(19) United States
(12) Patent Application Publication
(10) Pub. No.: US 2016/0161705 A1
(43) Pub. Date: Jun. 9, 2016

(54) REMOVABLE OPTICAL ASSEMBLY

(71) Applicant: MarqMetrix, Inc., Seattle, WA (US)

(72) Inventors: Brian James Marquardt, Seattle, WA (US); John Scott Van Vuren, Seattle, WA (US)

(21) Appl. No.: 14/957,528

(22) Filed: Dec. 2, 2015

Related U.S. Application Data
(60) Provisional application No. 62/087,784, filed on Dec. 4, 2014.
(60) Provisional application No. 62/107,988, filed on Jan. 26, 2015.

(51) Int. Cl. G02B 7/14; G01N 21/65; G02B 7/02

(52) U.S. Cl. CPC G02B 7/14; G02B 7/027; G01N 21/65; G01N 2201/065

(57) ABSTRACT

Examples embodiments of a removable optical assembly are disclosed. A removable optical assembly can be removably attached to a probe of an optical analytical instrument. The removable optical assembly can comprise a spherical optical element. An embodiment of the removable optical assembly can allow contact interrogation of a sample. In some embodiments, the removable optical assembly can comprise an internal optical element. In other embodiments, the removable optical assembly can comprise an external optical element. Manufacture of the removable optical assembly can comprise a monolithic embodiment or an assembled embodiment comprising a plurality of subassemblies. Embodiments of the removable optical assembly can be conical, cylindrical or planar is shape. The removable optical assembly can, in some embodiments, be consumable and/or disposable.

### RELATED APPLICATION

The subject patent application claims priority to each of U.S. Provisional Patent Application No. 62/087,784, filed 4 Dec., 2014, entitled “DISPOSABLE SPHERICAL OPTICAL INTERFACE,” and U.S. Provisional Patent Application No. 62/107,988, filed 26 Jan., 2015, and entitled “DISPOSABLE SPHERICAL OPTICAL INTERFACE.” The entireties of the aforementioned provisional applications are hereby incorporated herein by reference.

### TECHNICAL FIELD

The disclosed subject matter relates to analytical equipment, e.g., field deployable chemical analysis equipment. Embodiments of the disclosed subject matter relate to a removable optical component for analytical equipment comprising an optical spectrometer, e.g., a disposable spherical optical interface for a Raman spectrometer.

### BACKGROUND

By way of brief background, conventional analytical equipment, e.g., field deployable chemical analysis equipment, is generally configured to provide detailed analytical information to a user in the field, e.g., by enabling a user to carry an instrument to a sample for interrogation of the sample. As an example, a portable pH device allows a user to test the pH of a sample by moving the pH device to the sample, e.g., dipping a pH probe into a lake rather than taking a sample of the lake back to a benchtop pH device. Conventional analytical equipment continues to become increasingly sophisticated and ever more portable due, at least in part, to improvements in microelectronics, discoveries in the material sciences, advances in battery technology, and a demand for field deployable analytical grade instrumentation. In an aspect, spectrometers, such as Raman spectrometers, etc., are now moving from benchtop instruments to portable instruments. These conventional spectrometers generally employ fixed sample interfaces, e.g., sample interfaces that are not typically removable as part of operating the conventional spectrometer in the field. As such, conventional spectrometer sample interface elements, both benchtop and portable, typically require cleaning, e.g., between samples or sets of samples, prior to a measurement to ensure the optics are free of interfering contaminants or damage, etc. Further, conventional spectrometer sample interface elements generally are subject to high levels of care and protection, e.g., replacing a damaged sample probe can be costly, may require sending the conventional spectrometer into a service center resulting in a period of time in which the instrument is unavailable for use, etc. As such, despite being a desirable analytical tool, conventional spectrometers, portable or otherwise, can be improved as disclosed in the instant disclosure.

### BRIEF DESCRIPTION OF DRAWINGS

FIG. 1 is an illustration of an example conical removable optical assembly in accordance with aspects of the subject disclosure.

FIG. 2 is a depiction of a shrouded conic removable optical assembly comprising an identification component in accordance with aspects of the subject disclosure.

FIG. 3 illustrates example geometries of a shroud for a shrouded removable optical assembly in accordance with aspects of the subject disclosure.

FIG. 4 illustrates an example planar removable optical assembly having an auxiliary sample interface channel in accordance with aspects of the subject disclosure.

FIG. 5 illustrates an example tubular removable optical assembly with a capillary sample channel in accordance with aspects of the subject disclosure.

FIG. 6 illustrates an example conical removable optical assembly enabling sample retention in accordance with aspects of the subject disclosure.

FIGS. 7A-D depict example methods of packing removable optical assemblies in accordance with aspects of the subject disclosure.

FIG. 8 illustrates an example removable optical assembly comprising a supplemental sample interaction component in accordance with aspects of the subject disclosure.

FIGS. 9A-C depict example methods of forming a removable optical assembly in accordance with aspects of the subject disclosure.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Conventional portable analytical equipment is becoming sophisticated enough to compete with traditional benchtop instruments while allowing the instrument to be transported to the sample rather than transporting the sample to a laboratory. In the area of optical analytical instruments, portable spectrometers are emerging, allowing spectrometers to be used in the field rather than as a traditional benchtop instrument in a laboratory. In some embodiments, the portable spectrometer equipment can employ a probe component coupled to a controller component. The probe component can be affixed to the controller component, e.g., the probe component is typically inserted into a sample environment for interrogation and cleaned, as needed, between sample environment insertions.

A probe component is generally not considered as a ‘removable’ element of the portable spectrometer wherein removal of the probe, even where possible, is not generally performed as part of normal use of the instrument in the field. As such, as used herein with regard to the disclosed subject matter, the term ‘removable,’ or similar terms, is intended to convey that a ‘removable element’ can be readily removed as part of the typical use of the optical analytical instrument for interrogating samples, e.g., the removable element can be readily removed by a user in the field as part of normal use of a portable spectrometer for taking a spectrum of a sample in the field. Moreover, the term ‘removable’ as used herein is intended to connote that the removal is related to convenient replacement of the removable element with another element, such as to reduce cross contamination, to facilitate different sample environment conditions, to increase the ruggedness of a portable spectrometer by allowing for ready replacement of a damaged removable element, etc. As an analogous example, modern thermometers frequently employ removable probe covers that allow the thermometer to be used rapidly from one patient to another by simply removing the probe cover used with a first patient and replacing it with another cover before use on a second patient. This is in contrast to the conventional thermometer that needs to be cleaned/sterilized between patients, e.g., a thermometer that does not employ removable probe covers between patients can increase a likelihood of contaminating the second patient with germs from the first patient. Therefore, even where the example conventional thermometer might have a probe that can be removed via a process, e.g., for repair, servicing, occasional calibration, etc., this removal is not generally considered to be part of a ‘normal sampling procedure’ or ‘normal operation’ of the thermometer. As such, a repair/servicing process that includes removal of a probe is essentially different from the example removable probe covers, in as much as the removal of the probe cover can, in fact, generally be considered a typical part of the process of taking temperatures of different patients. In some embodiments, a ‘removable’ element can also be a ‘disposable’ element or a ‘consumable’ element, and the broader term ‘removable,’ as used herein, includes these concepts except where explicitly or inherently stated otherwise. As such, a removable probe cover, such as the example removable thermometer probe cover, can be considered a disposable item or a consumable item, e.g., an item that is intended to be replaced in normal use, such as between patients in the removable thermometer probe cover example. In some embodiments, a removable element can be retained after removal for service, cleaning, repair, refurbishment, etc., to allow for eventual reuse of the removable element.

Conventional spectrometers, both portable and benchtop, generally employ fixed sample interfaces, e.g., sample interfaces that are not considered as ‘removable’ as the term is used herein. As such, conventional spectrometer sample interface elements typically are cleaned and/or sterilized between samples, sets of samples, prior to sampling, etc., to remove interfering contaminants, vectors of infection, etc., from the sample interface. As an example, where a Raman spectrometer probe is used to check for surface bacteria in a meat processing plant, contaminating the probe with bacteria from a first sample could lead to contamination of other samples, false positive results, etc., where the probe is not cleaned between each sample. Cleaning or sterilizing the probe between samples markedly increases the time between samples. Even where a conventional Raman spectrometer probe does not directly contact a sample, reducing the need for cleaning between samples, the time between samples can be increased as a result of needing to position the probe and the sample in a prescribed manner to allow for effective capture of a Raman spectrum and avoiding contact with the sample itself to prevent contamination, e.g., there can be a specific probe to sample distance that must be maintained across multiple samples. TouchRaman™ (MarqMetrix Inc., Seattle, Wash.) probes can comprise a spherical optical element, e.g., BallProbe™ (MarqMetrix Inc., Seattle, Wash.), allowing, for example, highly effective Raman spectra to be taken, where the spherical optical element is in contact with a surface, e.g., touching the sample, hence the term TouchRaman™. In an aspect, a removable probe tip, e.g., a removable optical assembly, can comprise the spherical optical element and facilitate ready removal of the removable probe tip in normal field use. Returning to the example of checking meat for bacteria, by employing a removable probe tip, the probe tips can be removed and replaced with another tip between each sample, thereby increasing the speed between samples in comparison to the conventional cleaning/sterilizing between samples. Of note, other optical measurement technologies can be used with a removable optical assembly, such as, Raman spectroscopy, infrared (IR) spectroscopy, ultraviolet-visual (UV-Vis) spectroscopy, near infrared (NIR) spectroscopy, reflectance spectroscopy, absorption spectroscopy, scattering spectroscopy, fluorescence spectroscopy, or nearly any other optical technique utilizing a light source and detector. Various non-limiting examples of spherical optical technology for probes is found in U.S. Pat. Nos. 6,831,745 and 6,977,729, the entireties of which are hereby incorporated herein by reference.

A removable probe tip, e.g., a removable optical assembly, also facilitates rapid replacement of a damaged tip without needing to send in the spectrometer for repair. Furthermore, mass production of consumable removable probe tips can allow for reduced production costs on a per tip/probe basis. Moreover, users can simply be trained to exchange removable probe tips as compared to teaching cleaning, sterilization, inspection, repair, etc., skills with non-removable probes. As an example, disposable laboratory pipette tips allow users to simply discard used tips to reduce a likelihood of cross contamination. Additionally, where a removable optical assembly is disposable, a user can be more likely to sample in challenging environments, e.g., biologicals, adhesives, polymers, acids, etc., than they might be where there is a fear of damaging a conventional probe. In another aspect, different grades of removable optical assemblies can be available, allowing a user to remove and exchange a first quality probe tip with a second quality probe tip as needed. This benefit of a removable optical assembly can enable use of a spectrometer with lower cost tips until use of a more expensive tip can be needed. As an example, low cost probe tips with a lower quality optical element can be used in the field for general sampling and, where a spectrum of interest is detected, the user can readily remove the low cost probe tip and exchange it for a probe tip having a higher quality optic, to capture a better spectrum at the same location.

In some embodiments, a removable optical assembly can accommodate retention of a sample. In an aspect, a sample can be captured in the removable optical assembly in conjunction with interrogating the captured sample. This can allow the captured sample to be associated with the results of the sample interrogation and to be retained for future use. As an example, users with rudimentary training can be deployed to take samples in the field. These samples can be retained and associated with spectra captured in conjunction with the sample capture. The samples can then be retained and returned to a laboratory for further testing. Therefore, in the example, where a retained sample is associated with a spectrum of interest, the sample can be retrieved for further testing, such as by a more highly trained user than the user that captured the sample in the field. This aspect can reduce a cost of using portable optical instrumentation.

In some embodiments, optical analytical instruments can interact with components of a removable optical assembly to gather additional data on a sample. In an aspect, a removable optical assembly can comprise an identifier allowing the removable optical assembly, e.g., a retained sample and the associated spectral information, to be associated. This can reduce the need for a user to label a retained sample. In another aspect, a removable optical assembly can comprise additional sensors, microfluidics, etc., that can allow for additional interaction with a sample. As an example, a removable optical assembly can comprise a thermocouple and an optical turbidity sensor that can allow additional information, e.g., temperature and turbidity, to be captured and associated with a sample in conjunction with interrogation of the sample to generate spectral information. As a further example, a removable optical assembly can comprise a microfluidic element that can allow for movement, interaction, monitoring, etc., of portions of a sample, e.g., via microfluidic valves, channels, pumps, reactors, introduction of reagents, etc., in conjunction with capturing a spectrum and/or retention of the sample. Further, control of these supplemental components can be initiated by a component external to the removable optical assembly, e.g., via a portable instrument, via a server over a wireless link, etc. As an example, where an acidic sample is captured via a removable optical assembly, a pH sensor of the removable optical assembly can determine the acidity and, in response to determining an acidic environment, a microfluidic chamber can be filled with a portion of the sample before a determined amount of buffering agent, based on the measured volume and pH, is released in the balance of the sample prior to capturing spectral information for the now buffered sample. The example removable optical assembly can then be removed from the portable instrument and returned to a laboratory with a retained buffered sample and a retained acidic sample, enabling further testing of the buffered sample, the unbuffered subsample, review of the captured spectral information, and review of the measured pH at the time of sampling. In a continuation of this example, the removable optical assembly can further monitor the pH of the retained sample during transport to the lab, e.g., from sample capture to a later time, and continue to adjust the pH by subsequent injections of buffer, etc., into the sample. Of note, nearly any microfluidic process can be performed by a removable optical assembly, including, for example, subsampling, mixing, monitoring, venting, moving, initiating reactions, etc., without departing from the presently disclosed subject matter, although all such possibilities are not explicitly recited herein for the sake of clarity and brevity.

In an aspect, embodiments of a removable optical assembly can be constructed of nearly any material suitable to an expected sample environment. A removable optical assembly can comprise a suitable polymer, e.g., polypropylene (PP), polyethylene terepthalate (PET), silicone, polytetrafluoroethylene (PTFE), etc. A removable optical assembly can comprise other materials, such as, but not limited to, stainless steel, gold, or other metal; borosilicate or other glass; starches or other carbohydrates, etc.; or nearly any other material suitable to a particular sample environment. Moreover, materials can be machined, sintered, cast, injection molded, 3D-printed, etc., for example to form a body 110, optical element seat 130, shroud 250, etc., of the removable optical assembly. Moreover, in some embodiments, the spherical optical element can be separately manufactured and added to the body, either as part of a molding process, bonded with an adhesive, attached with a friction or press fit, mechanically captured, etc. In other embodiments, the spherical optical element can be co-formed with the body as part of a molding process, e.g., the spherical optical element can be formed, of the same or a different material, with the removable optical assembly in injection molding; can be formed, of the same or a different material, with the removable optical assembly in 3D printing; etc. Additionally, spherical optics can be manufactured from nearly any appropriate material, including the same or different materials as the body of a removable optical assembly. Non-limiting examples of spherical optic materials includes a polymer, glass, mineral, etc., depending on the optical properties suited to a given scenario. Of note, the term ‘spherical optical element,’ or similar terms, as used herein, generally means an optical element, e.g., a lens, etc., that has a spherical, or nearly spherical, geometry. Moreover, the term ‘spherical optical element,’ as used herein, also includes any optical element that conducts light via a portion of the optical element that comprises a curved surface approximating at least a portion of a sphere, for example, where sphere of optical glass has an shallow equatorial trench ground into it, such as to capture a retaining ring, etc., the resulting optical element, within the context of the instant disclosure, would still be considered a spherical optical element so long as light enters/exits the non-equatorial portions. As another example, an injection molded spherical optical element can comprise a protrusion, e.g., resembling a lollipop on a stick, and, within the context of the instant disclosure, would still be considered a spherical optical element. As a further example, an optical element comprising two individual hemispherical portions can also be considered a spherical element within the scope of the instant disclosure.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

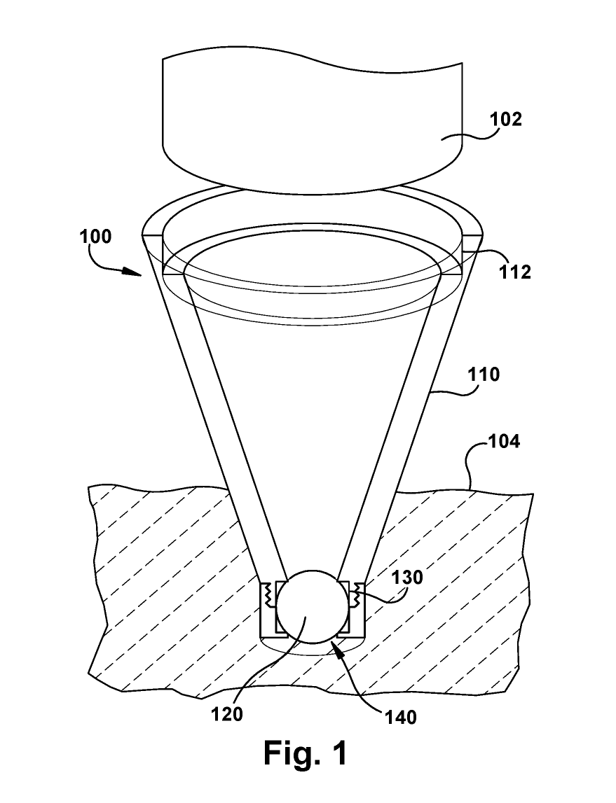

FIG. 1 is an illustration of an example conic removable optical assembly 100 in accordance with aspects of the subject disclosure. Assembly 100 can comprise a conical body portion 110, having an instrument connector portion 112. Instrument connector portion 112 enables assembly 100 to be removably connected to an optical analysis instrument 102. In an aspect, conic removable optical assembly 100 can be reminiscent of a disposable pipette tip. In an embodiment, connection of assembly 100 to instrument 102 facilitates transmission of light between instrument 102 and sample 104 via optical element 120. Instrument connector portion 112 can removably connect assembly 100 to instrument 102 in an oriented, e.g., via a key/keyway, alignment structures, alignment markings, etc., or non-oriented manner. Moreover, instrument connector portion 112 can employ a mechanical latch, a mechanical thread, a barb-type structure, a ball lock, a pin lock, friction, magnetic, electromagnetic, vacuum/pressure, etc., to removably connect assembly 100 to instrument 102. As examples, instrument connector portion 112 can employ a friction fit between assembly 100 to instrument 102, a threaded or twist on/off structure between assembly 100 to instrument 102, a removable adhesive between assembly 100 to instrument 102, etc. As other examples, instrument connector portion 112 can comprise a magnetic material that engages with a permanent magnetic, or electromagnetic, field generated by instrument 102 to removably connect assembly 100 to instrument 102. In a still further example, assembly 100 can be removably connected to instrument 102 via a pressure differential.

Light transmitted between instrument 102 and sample 104 can comprise an interrogating light transmitted from instrument 102 to sample 104, light returning from sample 104 to instrument 102, or combinations thereof. As illustrated for assembly 100, light can traverse a symmetrical axis and traverse optical element 120. Optical element 120 can be a spherical optical element. Light exiting optical element 120 can reach sample 104 and result in light being returned via optical element 120 to instrument 102 via the symmetrical axis. Of note, returned light can comprise reflected light, refracted light, emitted photons, ambient light, etc. In some embodiments, optical element 120 can be retained in conical body portion 110 at optical element seat 130. Optical element seat 130 can allow retention of separately manufactured optical elements, e.g., optical element 120, in assembly 100. As an example, optical element seat 130 can comprise an opening allowing optical element 120 to be press fit and retained by friction, adhesive, etc. As a further example, optical element seat 130 can comprise a threaded collar, snap on collar, etc., that retains optical element 120 against conical body portion 110. In some embodiments, e.g., where optical element 120 is co-formed with body portion 110, optical element 120 can be molecularly bonded to body portion 110 at optical element seat 130.

In an aspect, assembly 100 can enable contact-type spectroscopy, e.g., TouchRaman™, etc., wherein optical element 120 can be put in contact with sample 104. In embodiments where optical element 120 protrudes from body portion 110, e.g., the most distal portion of assembly 100 is a surface of optical element 120, contact-type spectroscopy can be performed on nearly any state of matter, e.g., solids, glasses, slurries, liquids, gases, etc., by putting optical element 120 in contact with sample 104 at sample interface 140. In embodiments where optical element 120 does not protrude from body portion 110, e.g., assembly 200, etc., contact-type spectroscopy can be limited to forms of matter than can enter a sample area proximate to optical element 120, typically liquids or gases. In some embodiments wherein optical element 120 facilitates interrogation of sample 104 at a distance, e.g., sample interface 140 is a determined distance from optical element 120, solid samples can be interrogated by non-protruding optical elements. The distance between optical element 120 and sample interface 140 can be determined by optics of instrument 102 in relation to optical element 120.

Conic removable optical assembly 100 can be readily removed where it becomes soiled, contaminated, damaged, etc., and a different conic removable optical assembly 100 can be removably connected to instrument 102. This can allow a user to avoid cleaning/sterilizing a conventional optical probe and can provide faster cycle times between sample interrogations, reduced user training encumbrances, selection of appropriate removable optical assemblies to suit an encountered sample environment, etc. In some embodiments, assembly 100 can be disposable or consumable. In other embodiments, assembly 100 can be retained after it is removed from instrument 102 and can be recycled, cleaned/reused, refurbished, etc.

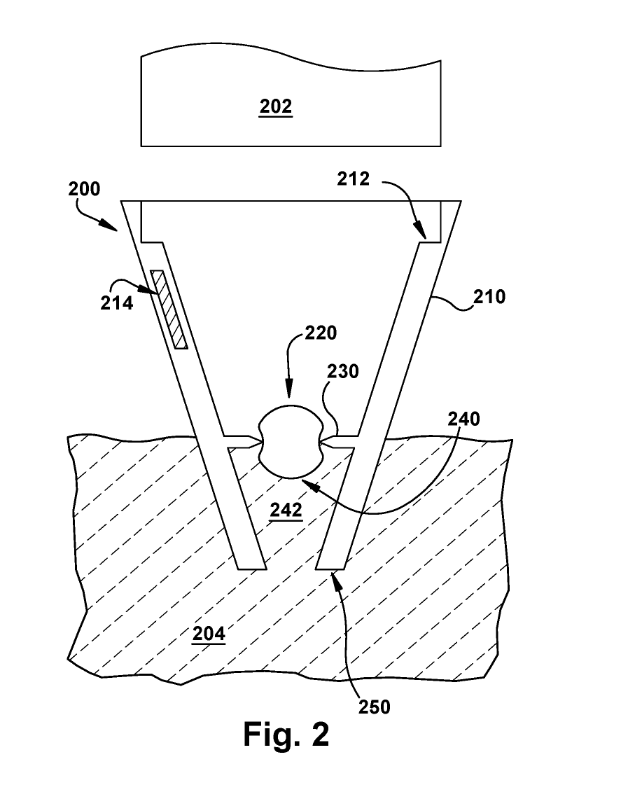

FIG. 2 is a depiction of a shrouded conic removable optical assembly 200, comprising an identification component, in accordance with aspects of the subject disclosure. Assembly 200 can comprise a conical body portion 210, having an instrument connector portion 212. Instrument connector portion 212 enables assembly 200 to be removably connected to an optical analysis instrument 202. Connection of assembly 200 to instrument 202 facilitates transmission of light between instrument 202 and sample 204 via optical element 220. In an aspect, sample 204 can be introduced into sample area 242 comprising sample interface region 240 that is proximate to optical element 220. In some embodiments sample 204 can comprise a liquid or a gas. In other embodiments, sample 204 can comprise a solid in particulate form allowing it to be introduced into sample area 242 so as to be interogatable at sample interface region 240 by light transmitted via optical element 220. In some embodiments wherein optical element 220 facilitates interrogation of sample 204 at a distance, e.g., a distance between sample interface region 240 and optical element 220 is sufficiently large enough that sample interface region 240 is external to the distal end of body portion 210, e.g., tip 250, solid samples can be interrogated. The distance between optical element 220 and sample interface region 240 can be determined by optics of instrument 202 in relation to optical element 220.

Optical element 220 can be supported by optical element seat 230. Optical element seat 230 can allow retention of optical element 220 in assembly 200. In an embodiment, optical element seat 230 can be formed integral with body portion 210. In these embodiments optical element 220 can be mated with optical element seat 230. As an example, optical element seat 230 can comprise an opening allowing optical element 220 to be press fit and retained by friction, adhesive, etc. As a further example, optical element seat 230 can comprise a threaded collar, snap on collar, etc., that retains optical element 220. In other embodiments, optical element seat 230 can be formed integral with optical element 220. In these embodiments, optical element seat 230, integral with optical element 220, can be mated with body portion 210. In further embodiments, optical element seat 230 can be separately formed from optical element 220 or body portion 210. In these embodiments, optical element seat 230 can be mated with body portion 210 and optical element 220. In some embodiments, e.g., where optical element 220 is co-formed with body portion 210 and optical element seat 230, optical element 220 can be molecularly bonded to body portion 210 via optical element seat 230, e.g., optical element seat 230 is monolithically formed as part of both optical element 220 and body portion 210. As an example, a low cost, injection molded assembly 200 can be manufactured with a mold allowing optical element 220, body portion 210, connector portion 212, and optical element seat 230 to be formed in a single injection step. While this example is generally to be associated with lower quality optical performance, the process is typically fast and very inexpensive in contrast to other methods comprising joining of subassemblies to form removable optical assembly 200.

In an aspect, shrouded conic removable optical assembly 200 comprises sample area 242 formed by the body portion 210 distal to optical element 220 and optical element seat 230. Shrouded conic removable optical assembly 200 can comprise technology to allow sample introduction into sample area 242 that is representative of sample 204. As an example, shrouded conic removable optical assembly 200 can comprise openings, vacuum, valves, channels, etc., that allow sample 204 to flow into, or be drawn into, sample area 242 so as to have sample 204 present in sample interface region 240 for interrogation by instrument 202 via optical element 220. In an aspect, tip 250 can serve to protect optical element 220 from damage via contact with a surface or object that might be present in sample 204, for example, allowing pond water to reach optical element 220 while preventing optical element 220 from impacting a rock on the pond bottom or a stick floating in the pond water.

In an aspect, shrouded conic removable optical assembly 200 further comprises ID component 214. In some embodiments, ID component 214 can be attached to, or be suspended in, a material forming a wall of body portion 210 of removable optical assembly 200, e.g., a label, an radio frequency identification (RFID) device, etc. In other embodiments, ID component 214 can be integral to removable optical assembly 200, for example, a laser etched identifier, etc. In some embodiments, ID component 214 can be read by instrument 202 and employed in correlating an identifiable removable optical assembly 200 with sample information, e.g., captured spectrum, geolocation of a sample, time of sampling, characteristics of the removable optical assembly used in the sampling, etc. As an example, instrument 202 can read the ID component 214 of a removable optical assembly 200 when a sample is interrogated along a reservoir, which can allow the time the sample was interrogated, location information for where the sample was interrogated, the type of optical element 220 used in removable optical assembly 200 for the sample interrogation, etc., to be associated with a spectrum captured in interrogating the sample. Moreover, where the example sample is retained, later identification of the retained sample can be based on ID component 214 data, e.g. facilitating automation of chain of custody processes.

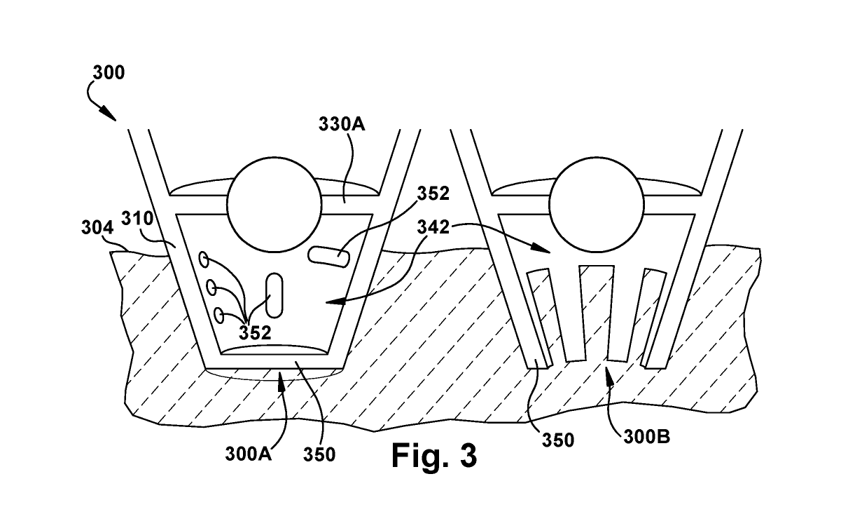

In an aspect, introduction of sample 204 into shrouded conic removable optical assembly 200 can be limited to sample area 242. As such, sample 204 can be excluded from entering the area between instrument 202 and the proximate side of optical element 220 and optical element seat 230. This can reduce the likelihood of fouling or contaminating instrument 202. In an aspect, where instrument 202 comprises a vacuum sampling technology, optical element seat 230 can comprise structures that allow vacuum to be communicated from instrument 202 into sample area 242, typically to the extent that sample can be drawn into sample area 242. As an example, optical element seat 230 can comprise a gas permeable membrane allowing liquid samples, e.g., 204, to be drawn into sample area 242 but still be excluded from the area closer to instrument 202. As another example, optical element seat 230 can comprise a one way flapper valve structure, channels, etc., where the vacuum sampling is metered to prevent drawing a liquid sample, e.g., 204, through the valve, channel, etc., into the area proximate to instrument 202. Moreover, where shrouded conic removable optical assembly 200 is structured to allow sample 204 to enter sample area 242 without vacuum from instrument 202, e.g., a cage structure, holes, slots, etc., optical element 220 and optical element seat 230 can simply seal off the area proximate to instrument 202 from sample 204, for example as shown in FIG. 3.

FIG. 3 illustrates example geometries for shrouded removable optical assemblies 300 in accordance with aspects of the subject disclosure. Shrouded removable optical assemblies 300 can employ different structures to regulate the introduction of sample 304 into sample area 342. In shrouded removable optical assembly 300A, holes 352 can be introduced to the walls of body portion 310A to allow sample 304 to enter sample area 342. Of note, holes 352 can be of any geometry, e.g., circular, oblong, slotted, slitted, square, etc. Moreover, the placement of holes 352 can be of any pattern and number, e.g., one square hole proximate to the optical element seat 330A; four slots 180-degrees from two circular holes; three angular slots placed at equal angular distances; etc. Furthermore, holes 352 can be of any size, e.g., small holes can restrict sample flow into sample area 342 but can also keep out smaller solids, gels, higher viscosity fluids; large holes can allow rapid introduction of sample 304 into sample area 342 but can also allow in larger solids and higher viscosity fluids; etc.

In some embodiments, tip 350 can be open, solid, or solid with one or more holes. In some embodiments, tip 350 can be removed and combined with holes 352, producing a fingerlike shroud, e.g., shrouded removable optical assembly 300B. In another embodiment, a shrouded removable optical assembly geometry can result in a shock absorbing structure, e.g., a rotational spring shroud geometry that is not illustrated. In a further embodiment, the shroud geometry can form a pump-type structure, wherein compression of the structure decreases the volume of sample area 342 and release of the compression allows sample area 342 to return to an uncompressed volume thereby drawing in sample 304 into sample area 342, also not illustrated. Of note, nearly any geometry of shrouded removable optical assembly is to be considered within the scope of the instant disclosure despite not being explicitly recited for clarity and brevity.

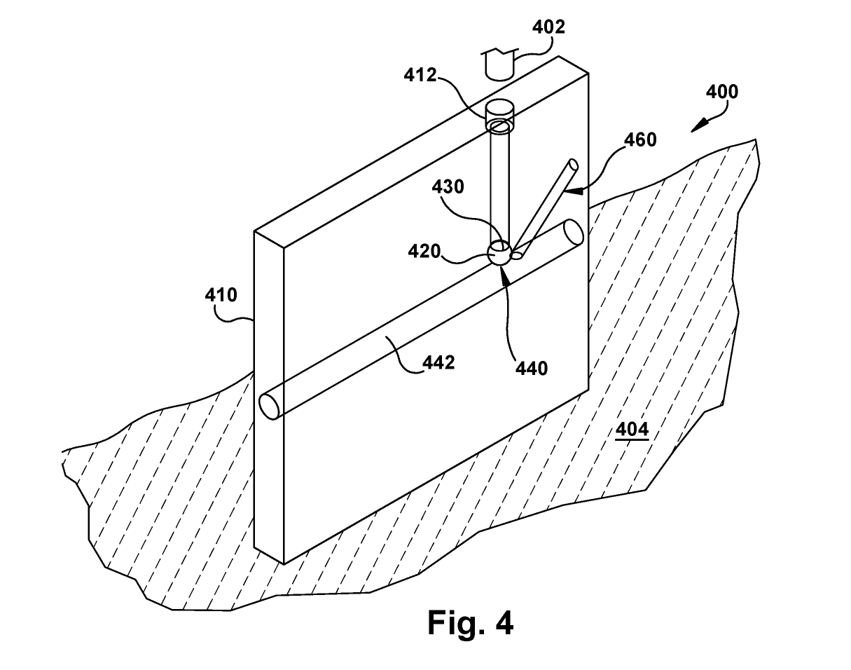

FIG. 4 illustrates an example planar removable optical assembly 400, having an auxiliary sample interface, in accordance with aspects of the subject disclosure. Assembly 400 can comprise a planar body portion 410, having an instrument connector portion 412. Instrument connector portion 412 enables assembly 400 to be removably connected to an optical analysis instrument 402. Connection of assembly 400 to instrument 402 facilitates transmission of light between instrument 402 and sample 404 via optical element 420. In an aspect, sample 404 can be introduced into sample area 442 comprising sample interface region 440 that is proximate to optical element 420. In some embodiments sample 404 can comprise a liquid or a gas. In other embodiments, sample 404 can comprise a solid in particulate form allowing it to be introduced into sample area 442.

Optical element 420 can be supported by optical element seat 430. Optical element seat 430 can allow retention of optical element 420 in assembly 400. In an embodiment, optical element seat 430 can be formed as part of body portion 410. In these embodiments optical element 420 can be inserted into optical element seat 430. As an example, optical element seat 430 can comprise an opening allowing optical element 420 to be press fit and retained by friction, adhesive, etc. As a further example, optical element seat 430 can comprise a threaded collar, snap in collar, etc., that retains optical element 420. In other embodiments, optical element seat 430 can be formed as part of optical element 420. In these embodiments, optical element seat 430 can be coupled to body portion 410. In further embodiments, optical element seat 430 can be separately formed from optical element 420 and body portion 410. In these embodiments, optical element seat 430 can be coupled to both body portion 410 and optical element 420. In embodiments optical element 420 can be co-formed with body portion 410 and optical element seat 430, e.g., optical element seat 430 is monolithically formed as part of both optical element 420 and body portion 410.

In an aspect, planar removable optical assembly 400 comprises sample area 442 formed in body portion 410, generally distal to optical element 420 and optical element seat 430. Planar removable optical assembly 400 can comprise features, e.g., channel 460, to facilitate sample introduction into sample area 442 that is representative of sample 404. As examples, planar removable optical assembly 400 can comprise openings, vacuum, valves, channels, etc., that allow sample 404 to flow into, or be drawn into, sample area 442 so as to have sample 404 present in sample interface region 440 for interrogation by instrument 402 via optical element 420. In an aspect, channel 460 can introduce a vacuum proximate to sample interface region 440 that can promote migration of sample 404 into sample interface region 440.

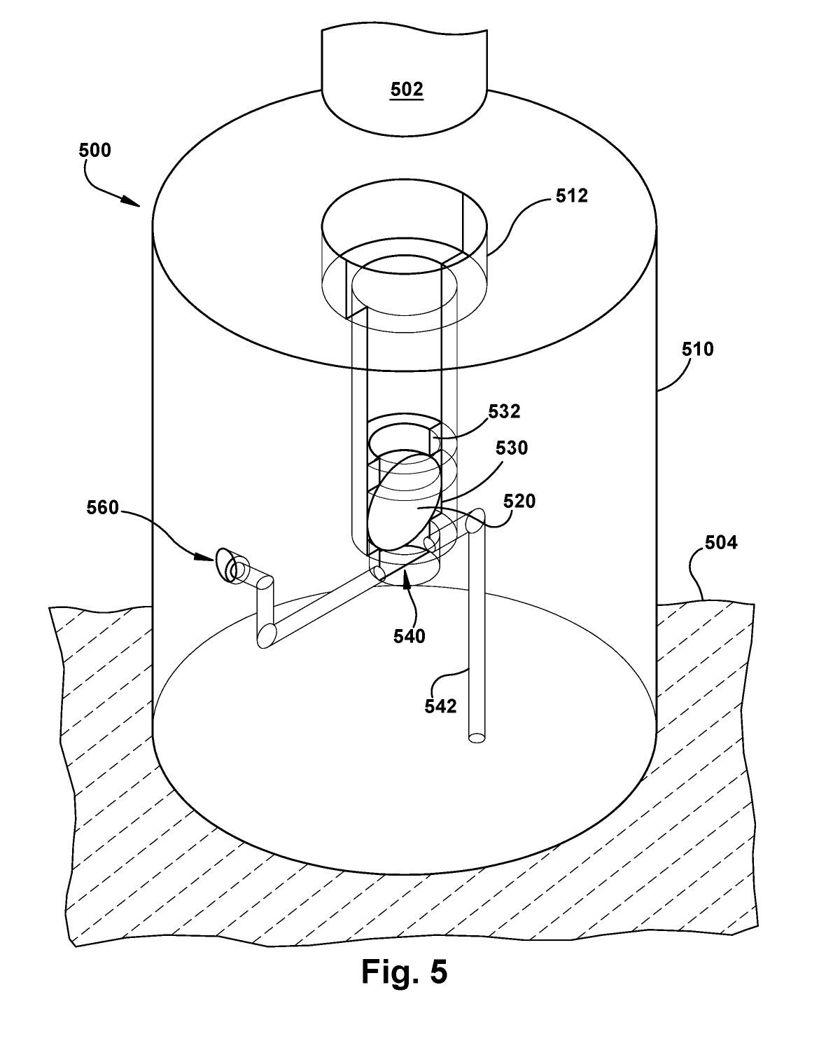

FIG. 5 illustrates an example tubular removable optical assembly 500 with a capillary sample channel, in accordance with aspects of the subject disclosure. Assembly 500 can comprise a cylindrical or tubular body portion 510, having an instrument connector portion 512. Instrument connector portion 512 enables assembly 500 to be removably connected to an optical analysis instrument 502. Connection of assembly 500 to instrument 502 facilitates transmission of light between instrument 502 and sample 504 via optical element 520, e.g., a spherical optical element. In an aspect, sample 504 can be introduced into sample area 542 comprising sample interface region 540 that is proximate to optical element 520. In some embodiments sample 504 can comprise a liquid or a gas. In other embodiments, sample 504 can comprise a solid in particulate form allowing it to be introduced into sample area 542. In an embodiment, sample area 542 can comprise a portion having a geometry that results in capillary motion of a liquid sample into sample interface region 540. Capillary motion can also be known as capillary action or wicking and can cause a liquid to flow as a result of surface tension and adhesiveness of a liquid. Capillary motion can cause a liquid sample to be drawn into sample interface region 540 without introducing a vacuum or other external force.

Optical element 520 can be supported by optical element seat 530. Optical element seat 530 can allow retention of optical element 520 in assembly 500. In an embodiment, optical element seat 530 can be formed as part of body portion 510. In these embodiments optical element 520 can be inserted into optical element seat 530. As an example, optical element seat 530 can comprise an opening allowing optical element 520 to be press fit and retained by friction, adhesive, etc. As a further example, optical element seat 530 can comprise a collar 532 that retains optical element 520. In other embodiments, optical element seat 530 can be formed as part of optical element 520. In these embodiments, optical element seat 530 can be coupled to body portion 510. In further embodiments, optical element seat 530 can be separately formed from optical element 520 and body portion 510. In these embodiments, optical element seat 530 can be coupled to both body portion 510 and optical element 520. In embodiments optical element 520 can be co-formed with body portion 510 and optical element seat 530, e.g., optical element seat 530 is monolithically formed as part of both optical element 520 and body portion 510.

In an aspect, tubular removable optical assembly 500 comprises sample area 542 formed in body portion 510, generally distal to optical element 520 and optical element seat 530. Tubular removable optical assembly 500 can comprise features, e.g., channel 560, to facilitate sample introduction into sample area 542 that is representative of sample 504. As examples, tubular removable optical assembly 500 can comprise openings, vacuum, valves, channels, capillary channels, etc., that allow sample 504 to flow into, or be drawn into, sample area 542 so as to have sample 504 present in sample interface region 540 for interrogation by instrument 502 via optical element 520. In an aspect, sample area 542 can be a narrow channel to cause sample introduction via capillary motion, however, in other embodiments, channel 560 can introduce a vacuum proximate to sample area 542 that can promote migration of sample 504 into sample interface region 540, particularly where sample area 542 proportions do not induce sufficient, if any, capillary motion of sample 504.

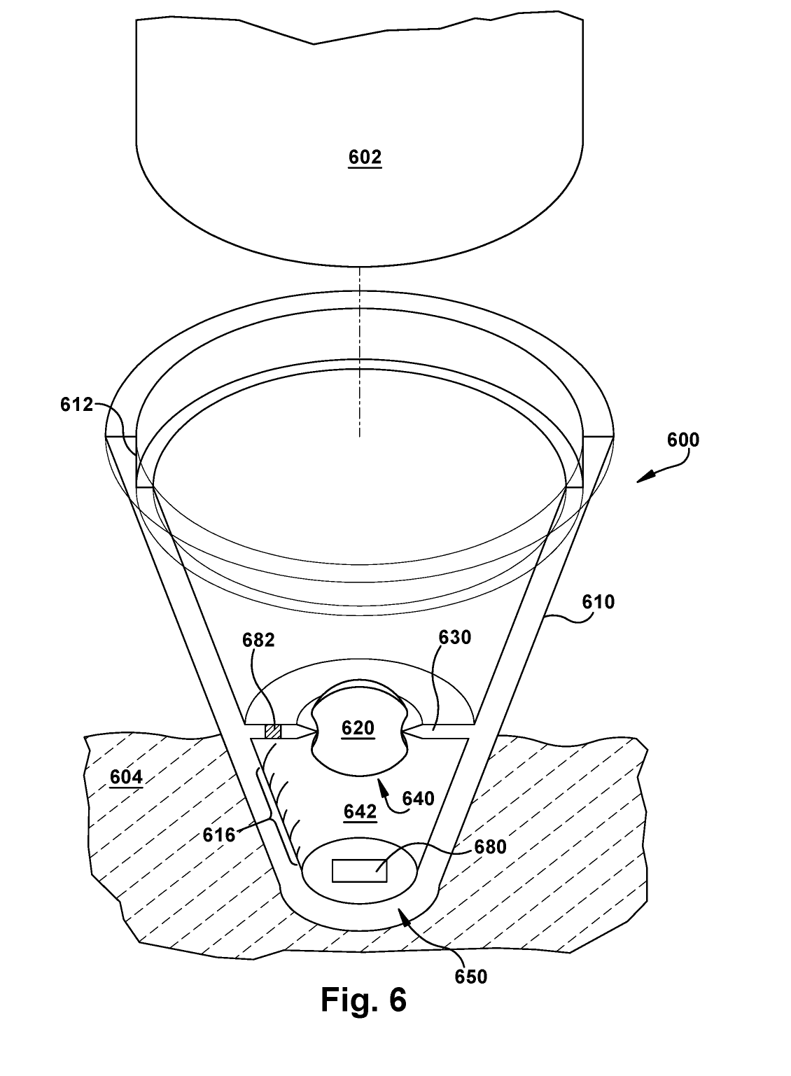

FIG. 6 illustrates an example conical removable optical assembly 600 enabling sample retention in accordance with aspects of the subject disclosure. Assembly 600 can comprise a conical body portion 610, having an instrument connector portion 612. Instrument connector portion 612 enables assembly 600 to be removably connected to an optical analysis instrument 602. Connection of assembly 600 to instrument 602 facilitates transmission of light between instrument 602 and sample 604 via optical element 620. In an aspect, sample 604 can be introduced into sample area 642 comprising sample interface region 640 that is proximate to optical element 620. In some embodiments sample 604 can comprise a liquid or a gas. In other embodiments, sample 604 can comprise a solid in particulate form allowing it to be introduced into sample area 642 so as to be interogatable at sample interface region 640 by light transmitted via optical element 620.

Optical element 620 can be supported by optical element seat 630. Optical element seat 630 can allow retention of optical element 620 in assembly 600. In an embodiment, optical element seat 630 can be formed integral with body portion 610. In these embodiments optical element 620 can be mated with optical element seat 630. As an example, optical element seat 630 can comprise an opening allowing optical element 620 to be press fit and retained by friction, adhesive, etc. As a further example, optical element seat 630 can comprise a collar that can retain optical element 620. In other embodiments, optical element seat 630 can be formed integral with optical element 620. In these embodiments, optical element seat 630, integral with optical element 620, can be mated with body portion 610. In further embodiments, optical element seat 630 can be separately formed from optical element 620 or body portion 610. In these embodiments, optical element seat 630 can be mated with body portion 610 and optical element 620. In some embodiments, optical element 620 can be co-formed with body portion 610 and optical element seat 630, e.g., optical element seat 630 is monolithically formed as part of both optical element 620 and body portion 610.

In an aspect, conic removable optical assembly 600 comprises sample area 642 formed by the body portion 610 distal to optical element 620 and optical element seat 630. Conic removable optical assembly 600 can comprise technology to allow sample introduction into sample area 642 that is representative of sample 604. As an example, conic removable optical assembly 600 can comprise openings, vacuum, valves, channels, etc., that allow sample 604 to flow into, or be drawn into, sample area 642 so as to have sample 604 present in sample interface region 640 for interrogation by instrument 602 via optical element 620. In an aspect, tip 650 can serve to protect optical element 620 from damage via contact with a surface or object that might be present in sample 604.

In some embodiments, conic removable optical assembly 600 can comprise mechanisms, e.g., 680, 682, etc., that can cause retention of sample 604 in sample area 642. In an embodiment, mechanism 680 and 682 can each be one way valves, such as one way flapper valves, that can allow sample 604 to be drawn into sample area 642 past a flexible membrane that returns to a sealing position after the sample drawing force is removed. In the sealing position, the flexible membrane can trap the sample in sample area 642. In another embodiment, mechanism 680 can be a one way valve and mechanism 682 can be a gas permeable membrane allowing a liquid sample to be drawn into sample area 642 past the one way valve of mechanism 680 via a drop in pressure caused by removing gases in sample area 642 through the gas permeable membrane of mechanism 682. If all the gas is removed from area 642, in this example, a liquid sample will not be drawn past the gas permeable membrane of mechanism 682, trapping the liquid sample in sample area 642. In some embodiments, mechanism 680 and/or 682 can comprise a cap, lid, plug, etc., which can be actuated by a user to close off sample area 642 after a satisfactory volume of sample is introduced thereto. The example cap, lid, plug, etc., can, in some instances, be tethered to conic removable optical assembly 600, such as by an integral, flexible portion between the cap, lid, plug, etc., and the conic removable optical assembly 600. In an aspect, conic removable optical assembly 600 can comprise volume indicator 616. In some embodiments, volume indicator 616 can be similar to measuring cup markings and can enable measurement of a volume of sample present in sample area 642. Of note, while the retention of sample in sample area 642 is illustrated with conic removable optical assembly 600, the same or similar features can be employed in planar, cylindrical, tubular, or other geometries of removable optical assembly.

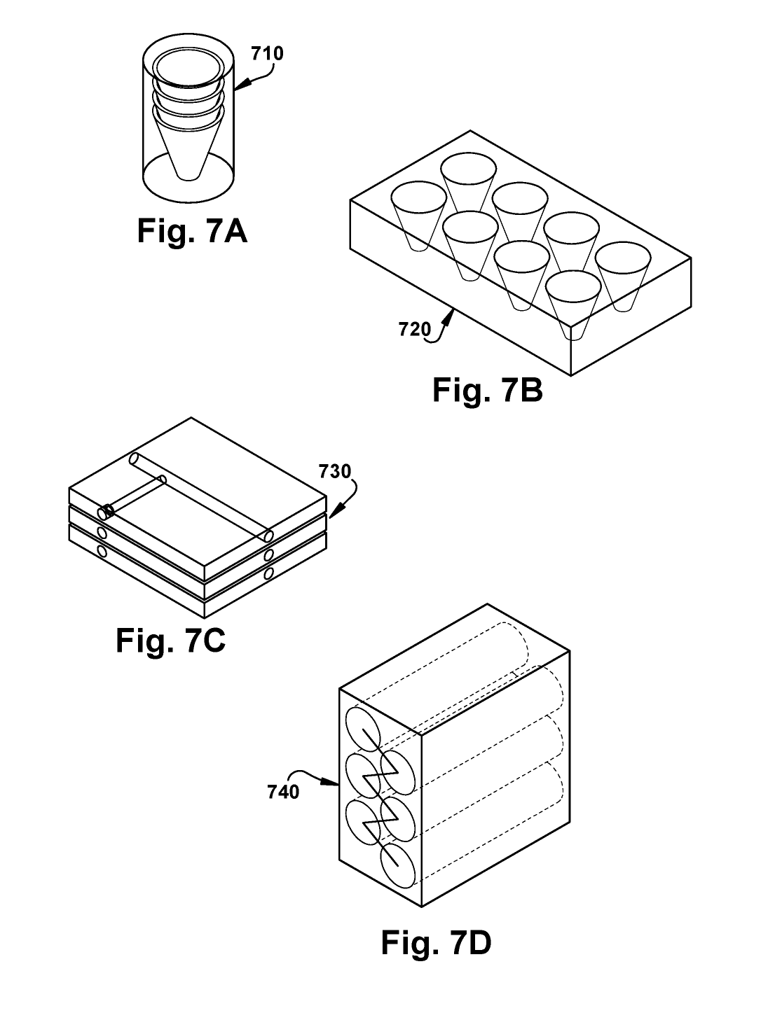

FIGS. 7A-D illustrate example removable optical assembly packing geometries, 710-740, in accordance with aspects of the subject disclosure. The determined geometry of a removable optical assembly, e.g., 100, 200, etc., can enable a stacked-nesting geometry, see 710, of a plurality of removable optical assemblies. This can provide spatially efficient storage of ready to use removable optical assemblies, used/removed removable optical assemblies, etc. As an example, an automated optical analysis instrument can be equipped with tubes of ready to use removable optical assemblies, e.g., a drone equipped with a portable spectrometer and a supply of removable optical assemblies can then be used to go take samples in places that can be dangerous or difficult for a human user to get to, such as in a contaminated environment (nuclear/chemical spills, war, etc.), in hard to get to locations, e.g., a drone can be flown in to sample a mountain lake, etc., or where computer precision/automation can be desirable, e.g., grid sampling of a large geographic area, for example, hundreds of square miles of ocean in a petroleum spill scenario, etc. Another packing geometry can include a planar array, e.g., see 720. Of note, the planar array can comprise a plurality of spherical optical elements integrated into the ‘wells’, e.g., of a microwell plate, microtiter plate, etc., not illustrated for clarity, allowing a spectrometer probe to be removably connected to each of the plurality of wells to interrogate samples located therein. As an example, the spectrometer probe can be stepped between wells and, at each well, can interface with a spherical optical element associated with interrogating a sample located at said well. In another embodiment, planar removable optical assemblies can be stacked without nesting, e.g., see 730. In a further embodiment, cylindrical or tubular removable optical assemblies can be also be stacked without nesting, see 740, in a manner similar to ammunition in a magazine. In some embodiments, stacking tubular removable optical assemblies can be a single stack (not illustrated), a staggered stack (e.g., 740), etc., that allows the tubular removable optical assemblies to feed to a feed port (not illustrated) where they can be accessed for use with an optical analytical instrument.

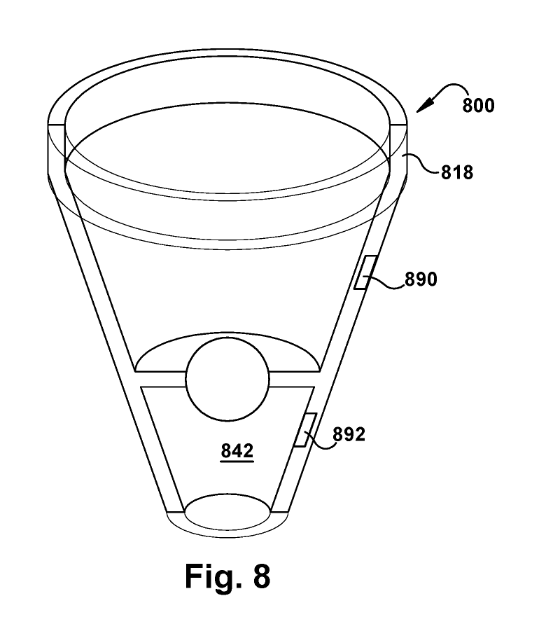

FIG. 8 illustrates an example removable optical assembly 800, comprising a supplemental sample interaction component, in accordance with aspects of the subject disclosure. Removable optical assembly 800 can comprise communication interface component 818 that can enable communication between removable optical assembly 800 and another device, e.g., optical analytical instrument 102, 202, 402, 502, 602, etc. In some embodiments, the other device can be a mobile device, a laptop, a server, etc., and communication can be via a wireless link. In an aspect, communication component 818 can enable interaction with an ID component, e.g., 214, etc. In another aspect, communication component 818 can enable interaction with a tip interaction component interface 890.

Tip interaction component interface 890 can enable communication with one or more tip interaction component(s) 892. Communications with a tip interaction component 892, via tip interaction component interface 890, can comprise control communication, data acquisition communication, capability query communication, status communication, etc. Tip interaction component(s) 892 can comprise a sensor, for example a thermocouple, a pH sensor, a salinity sensor, a turbidity sensor, etc. Tip interaction component(s) 892 can further comprise a microfluidic element, for example a valve, a pump, a reactor, a mixer, a sampler, a reagent reservoir, etc.

In an aspect, tip interaction component(s) 892 can enable additional data, e.g., data in addition to a spectrum, to be gathered with regard to a sample, or subsample thereof, introduced into sample area 842. As an example, tip interaction component(s) 892 can comprise a thermocouple that can enable capture of sample temperature data. This information can be relayed, via tip interaction component interface 890 to another device, such as an attached optical analytical instrument via communication interface component 818, a tablet computer via a wireless link, etc.

In some embodiments, tip interaction component(s) 892 can take sub samples of a sample introduced and/or interacted with in sample area 842. As an example, where tip interaction component(s) 892 comprise a pH sensor, microfluidic components, and microfluidic reservoirs of reagents, removable optical assembly 800 can be instructed, via communication interface component 818, to titrate a subsample of a sample introduced into sample area 842. Numerous other examples can be readily appreciated and are within the scope of the instant disclosure despite not being explicitly recited herein for the sake of clarity and brevity.

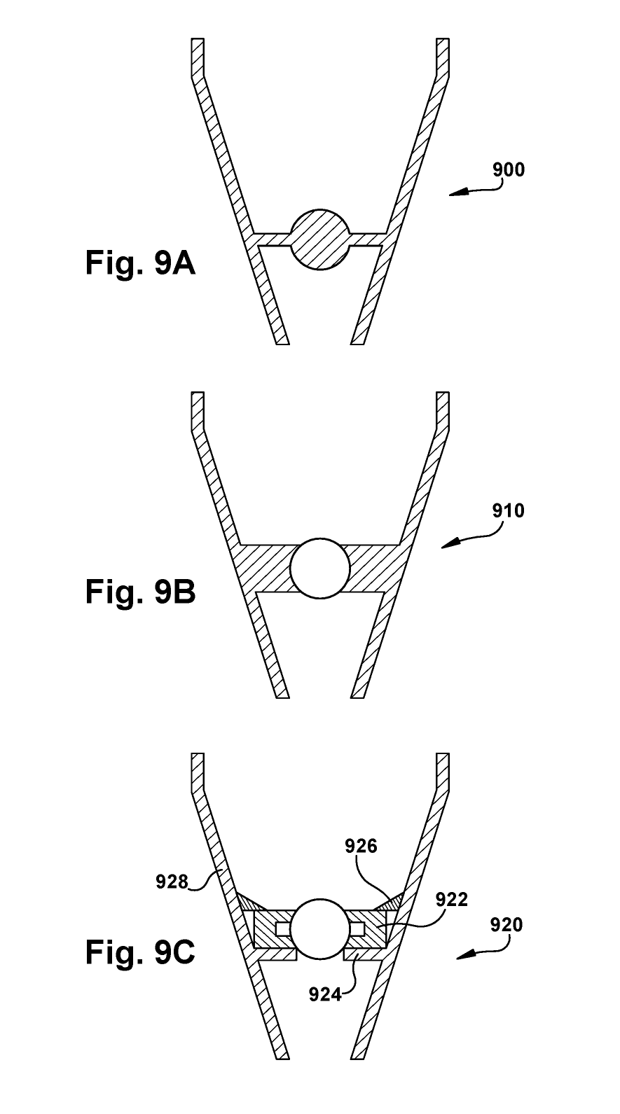

FIGS. 9A-C illustrate example methods of forming a removable optical assembly in accordance with aspects of the subject disclosure. Illustrated at 900, of FIG. 9A, is a monolithic removable optical assembly. As is illustrated, the monolithic removable optical assembly 900 can be formed as a single assembly, e.g., the optical element, optical element seat, body, coupling portion, shroud, fluidics, etc., can all be formed as one integral component rather than being assembled from subassemblies. Formation of monolithic removable optical assembly 900 can be via 3D printed, injection molding, etc. Typically, monolithic removable optical assembly 900 comprises an optical element that can provide satisfactory but not excellent performance characteristics. Additionally, a typical monolithic removable optical assembly 900 can lack more complex structures and components that can be more easily formed via assembling separate subassemblies. However, a typical monolithic removable optical assembly 900 can typically be mass-produced to drive down per unit cost and generally can be thought of as an economy-level removable optical assembly.

Illustrated at 910, of FIG. 9B, is a removable optical assembly formed from a plurality of subassemblies, typically in an automated manner. As is illustrated, the bulk of the structures forming removable optical assembly 910 can be produced around an optical element subassembly. In an aspect, optical element subassembly can be separately produced and married to other subassemblies in a generally automated manner. As an example, a spherical glass lens can be ground in a first manufacturing process. This glass optical element can then be placed, for example, in an injection-molding fixture wherein the balance of removable optical assembly 910 can be formed by being injection molded around the example glass optical element. Similar processes can be performed for 3D printing, etc., the other subassemblies of removable optical assembly 910. Typically, removable optical assembly 910 comprises an optical element that can provide good to excellent performance characteristics, e.g., better than the optical element typically associated with the monolithic removable optical assembly 900. However, where removable optical assembly 910 is generally formed in an automated manner, excellent quality optics can be considered ‘overkill’ (though still within the scope of the instant disclosure) and in practice optical elements of removable optical assembly 910 will typically be moderate quality optics, e.g., high quality plastic optics, glass optics, etc., but less likely to be mineral optics, etc. Removable optical assembly 910 can typically be mass-produced to drive down per unit cost and generally can be thought of as a mid-level removable optical assembly.

Illustrated at 920, of FIG. 9C, is a removable optical assembly formed from a plurality of subassemblies, generally in a less automated manner. As is illustrated, the bulk of the structures forming removable optical assembly 920 can be individually produced and assembled around, or married to, an optical element subassembly. Assembly is of optical assembly 920 can typically include fewer automated processes than 910, so as to produce a high quality optical assembly around a high quality optical element. As an example, a spherical sapphire lens can be centerless ground and polished in a first manufacturing process. This sapphire optical element can then be, for example, pressure fit into an optical element carrier 922, which subassembly can then be placed into an optical element seat 924 that can, for example, be braised 926 into a stainless steel body 928. Typically, removable optical assembly 920 comprises a high quality optical element that can provide excellent performance characteristics. However, this generality is nonlimiting and it will be noted that other qualities of optical elements can be employed in removable optical assembly 920. Due to the high levels of precision associated with removable optical assembly 920, mass production can be difficult and per unit cost can generally be expected to be greater than removable optical assembly 900 or 910. Removable optical assembly 920 generally can be thought of as a premium-level removable optical assembly. It will be noted that other grades of removable optical assembly are within the scope of the instant disclosure although they are not recited for brevity and clarity.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like can refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Furthermore, the terms “user,” “technician,” “operator,” “consumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; third generation partnership project, long term evolution; third generation partnership project universal mobile telecommunications system; third generation partnership project 2, ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced.

What has been described above includes examples of systems and/or methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. An assembly, comprising:
a body portion enabling a removable connection to an optical analytical instrument;
an optical element seat portion connected to the body portion; and
a spherical optical element connected to the optical element seat portion.

2. The assembly of claim 1, wherein the body portion comprises a plastic polymer material.

3. The assembly of claim 1, wherein the body portion comprises a glass material.

4. The assembly of claim 1, wherein the body portion comprises a metal material.

5. The assembly of claim 1, wherein the spherical optical element is formed from a plastic polymer material.

6. The assembly of claim 1, wherein the spherical optical element is formed from a glass material.

7. The assembly of claim 1, wherein the body portion and the optical element seat portion are integrally formed.

8. The assembly of claim 7, wherein the spherical optical element is mated to the optical element seat portion integrally formed with the body portion.

9. The assembly of claim 1, wherein the optical element seat portion and the spherical optical element are integrally formed.

10. The assembly of claim 9, wherein the body portion is mated to the optical element seat portion integrally formed with the spherical optical element.

11. The assembly of claim 1, wherein the body portion, the optical element seat portion, and the spherical optical element are integrally formed.

12. The assembly of claim 1, wherein the spherical optical element is positioned to enable contact with a solid surface of a sample.

13. The assembly of claim 1, wherein the spherical optical element is positioned to enable contact a sample introduced into an internal sample area of the body portion.

14. The assembly of claim 13, wherein the internal sample area of the body portion comprises a channel that produces capillary action with a liquid sample.

15. The assembly of claim 13, wherein the internal sample area of the body portion is connected to a structure that enables a decrease in gas pressure to be communicated to the internal sample area resulting in a sample being drawn into the internal sample area.

16. The assembly of claim 1, wherein the assembly is conical, cylindrical, or planar.

17. The assembly of claim 16, wherein the assembly is adapted to be nested within another assembly identical to the assembly.

18. An optical analytical instrument probe, comprising:
a connector that is removably attachable to a removable optical assembly;
a body portion enabling connection of the removable optical assembly to the connector; and
an optical element seat portion connected to the body portion and a spherical optical element.

19. The optical analytical instrument probe of claim 18, wherein the spherical optical element comprises a first optical surface that approximates, or is, a portion of a spherical surface.

20. The optical analytical instrument probe of claim 18, wherein the body portion, the optical element seat portion, and the spherical optical element are formed as a monolithic element.

21. The optical analytical instrument probe of claim 18, wherein the monolithic element is formed by a 3D printing process or an injection-molding process.

22. A computer readable storage device comprising executable instructions that, in response to execution, cause a system comprising a processor to perform operations, comprising:
selecting a removable optical assembly based on a characteristic of the removable optical assembly;
removably connecting the removable optical assembly to an optical analytical instrument probe; and
optically interrogating a sample via the removable optical assembly, wherein the removable optical assembly comprises:
a body portion enabling a removable connection to an optical analytical instrument;
an optical element seat portion connected to the body portion; and
a spherical optical element connected to the optical element seat portion.

23. The computer readable storage device of claim 22, wherein the characteristic of the removable optical assembly is a level of optical quality for the spherical optical element.

24. The computer readable storage device of claim 22, wherein the characteristic of the removable optical assembly is a unit cost of the removable optical assembly.

25. The computer readable storage device of claim 22, wherein the characteristic of the removable optical assembly is a type of material from which the body portion of the removable optical assembly is formed.
